(19) United States
(12) Patent Application Publication
(10) Pub. No.: US 2016/0278013 A1
(43) Pub. Date: Sep. 22, 2016

(54) PHY FOR ULTRA-LOW POWER WIRELESS RECEIVER

(71) Applicant: QUALCOMM Incorporated, San Diego, CA (US)

(72) Inventors: Stephen Jay Shellhammer, Ramona, CA (US); Bin Tian, San Diego, CA (US); Sameer Vermani, San Diego, CA (US); Scott Hooten, San Diego, CA (US)

(21) Appl. No.: 15/073,519

(22) Filed: Mar. 17, 2016

Related U.S. Application Data
(60) Provisional application No. 62/136,290, filed on Mar. 20, 2015.

(51) Int. Cl. H04W 52/02; H04W 52/52; H04W 84/12

(52) U.S. Cl. CPC H04W 52/0225; H04W 84/12; H04W 52/52

(57) ABSTRACT

Methods, systems, and devices are described for wireless communication at a wireless device. An access point (AP) may identify a pending communication for a wireless device and transmit a wakeup message comprising a device specific sequence to a companion radio of the device. The device may receive the wakeup message using the companion radio, decode the message to obtain a device specific sequence, and activate a primary radio. The wakeup message may include a preamble, a signal field, and a data field. In some cases, the wireless device may demodulate the wakeup message using ON-OFF keying (OOK) modulation. The AP and the device may then exchange data using the primary radio.

### CROSS REFERENCES

The present application for patent claims priority to U.S. Provisional Patent Application No. 62/136,290 by Shellhammer et al., entitled “PHY For Ultra-Low Power Wireless Receiver,” filed Mar. 20, 2015, assigned to the assignee hereof, and expressly incorporated by reference herein.

### BACKGROUND

The following relates generally to wireless communication, and more specifically to a physical (PHY) layer for an ultra-low power wireless receiver.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a wireless fidelity (Wi-Fi) (i.e., IEEE 802.11) network may include an access point (AP) that may communicate with one or more station (wireless devices) or mobile devices. The AP may be coupled to a network, such as the Internet, and may enable a mobile device to communicate via the network (or communicate with other devices coupled to the access point). A wireless device may communicate with a network device bi-directionally.

In some cases a wireless device may have a limited amount of battery power. Even if the wireless device is operating in a sleep mode, it may periodically activate a radio, such as a WLAN transceiver, to communicate with an AP. Operating the radio may consume a significant amount of power and may result in a short operating period for the wireless device before the battery must be recharged or replaced. In some cases, recharging or replacing the battery may not be feasible. Thus, periodically activating the radio may limit the ability to operate for long periods of time.

### SUMMARY

Systems, methods, and apparatuses supporting a physical layer for an ultra-low power wireless receiver are described. An access point (AP) may identify a pending communication for a wireless device and transmit a wakeup message comprising a device specific sequence to a companion radio of the device. The device may receive the wakeup message using the companion radio, decode the message to obtain a device specific sequence, and activate a primary radio. The wakeup message may include a preamble, a signal field, and a data field. In some cases, the wireless device may demodulate the wakeup message using a ternary ON-OFF keying (OOK) modulation. The AP and the device may then exchange data using the primary radio.

A method of wireless communication is described. The method may include receiving a wakeup message at a first radio, decoding the wakeup message to obtain a device specific sequence, and activating a second radio based at least in part on decoding the device specific sequence.

An apparatus for wireless communication is described. The apparatus may include a wakeup message manager for receiving a wakeup message at a first radio, a decoder for decoding the wakeup message to obtain a device specific sequence, and a radio activator for activating a second radio based at least in part on decoding the device specific sequence.

A further apparatus for wireless communication is described. The apparatus may include a processor, memory in electronic communication with the processor, and instructions stored in the memory and operable, when executed by the processor, to cause the apparatus to receive a wakeup message at a first radio, decode the wakeup message to obtain a device specific sequence, and activate a second radio based at least in part on decoding the device specific sequence.

A non-transitory computer-readable medium storing code for wireless communication is described. The code may include instructions executable to receive a wakeup message at a first radio, decode the wakeup message to obtain a device specific sequence, and activate a second radio based at least in part on decoding the device specific sequence.

In some examples of the method, apparatuses, or non-transitory computer-readable medium described herein, the wakeup message comprises a preamble, a signal field and a data field, wherein the device specific sequence is located within the data field. Additionally or alternatively, in some examples the preamble comprises an automatic gain control (AGC) field and a pseudo-random noise (PN) field.

In some examples of the method, apparatuses, or non-transitory computer-readable medium described herein, the signal field indicates the length of the data field. Additionally or alternatively, in some examples a DC value of a baseband representation of the preamble, the signal field, the data field, or any combination thereof is zero. In some examples of the method, apparatuses, or non-transitory computer-readable medium described herein, the wakeup message is modulated using a ternary OOK modulation comprising bits represented with positive and negative amplitude signals. Some examples include demodulating the wakeup message modulated with ternary OOK using binary OOK modulation, wherein decoding the wakeup message is based at least in part on the demodulation.

In some examples of the method, apparatuses, or non-transitory computer-readable medium described herein, the data field comprises a physical layer service data unit (PSDU) and a tail of zero-valued bits. Additionally or alternatively, in some examples the signal field, the data field, or any combination thereof is based at least in part on a spreading code.

Some examples of the method, apparatuses, or non-transitory computer-readable medium described herein may further include processes, features, means, or instructions for demodulating the wakeup message using OOK modulation, wherein decoding the wakeup message is based at least in part on the demodulation. Additionally or alternatively, in some examples the first radio is a low power receiver.

In some examples of the method, apparatuses, or non-transitory computer-readable medium described herein, the first radio is a super regenerative receiver (SRR). Additionally or alternatively, in some examples the second radio has a higher throughput capacity than the first radio.

In some examples of the method, apparatuses, or non-transitory computer-readable medium described herein, the second radio is a WLAN radio or a wireless wide area network (WWAN) radio.

A method of wireless communication is described. The method may include identifying a pending communication for a wireless device, transmitting a wakeup message to a first radio of the wireless device, and exchanging data with a second radio of the wireless device based at least in part on the pending communication and the wakeup message.

An apparatus for wireless communication is described. The apparatus may include a pending communications manager for identifying a pending communication for a wireless device, a BS wakeup message manager for transmitting a wakeup message to a first radio of the wireless device, and a communications manager for exchanging data with a second radio of the wireless device based at least in part on the pending communication and the wakeup message.

A further apparatus for wireless communication is described. The apparatus may include a processor, memory in electronic communication with the processor, and instructions stored in the memory and operable, when executed by the processor, to cause the apparatus to identify a pending communication for a wireless device, transmit a wakeup message to a first radio of the wireless device, and exchange data with a second radio of the wireless device based at least in part on the pending communication and the wakeup message.

A non-transitory computer-readable medium storing code for wireless communication is described. The code may include instructions executable to identify a pending communication for a wireless device, transmit a wakeup message to a first radio of the wireless device, and exchange data with a second radio of the wireless device based at least in part on the pending communication and the wakeup message.

In some examples of the method, apparatuses, or non-transitory computer-readable medium described herein, the wakeup message comprises a preamble, a signal field and a data field, wherein the device specific sequence is located within the data field. Additionally or alternatively, in some examples the preamble comprises an AGC field and a PN field.

In some examples of the method, apparatuses, or non-transitory computer-readable medium described herein, the signal field indicates the length of the data field. In some examples, the length of the data field indicates the length of a media access control (MAC) frame in bytes. In some examples, a parity bit is appended to the signal field, and the signal field is then encoded with a repetition-by-three forward error correction (FEC) code. Additionally or alternatively, in some examples a DC value of a baseband representation of the preamble, the signal field, the data field, or any combination thereof is zero.

In some examples of the method, apparatuses, or non-transitory computer-readable medium described herein, the data field comprises a physical layer service data unit (PSDU) and a tail of zero-valued bits. Additionally or alternatively, in some examples the signal field, the data field, or any combination thereof is based at least in part on a spreading code.

Some examples of the method, apparatuses, or non-transitory computer-readable medium described herein may further include processes, features, means, or instructions for modulating a wakeup message using OOK modulation, wherein transmitting the wakeup message is based at least in part on the modulation. Additionally or alternatively, in some examples the first radio is a low power receiver.

In some examples of the method, apparatuses, or non-transitory computer-readable medium described herein, the first radio is a super regenerative receiver (SRR). Additionally or alternatively, in some examples the second radio has a higher throughput capacity than the first radio.

In some examples of the method, apparatuses, or non-transitory computer-readable medium described herein, the second radio is a WLAN radio or a WWAN radio.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) (also known as a wireless fidelity (Wi-Fi) network) for the physical (PHY) layer of an ultra-low power wireless receiver configured in accordance with various aspects of the present disclosure;

FIG. 2 illustrates an example of a wireless communications subsystem that supports the PHY layer for an ultra-low power wireless receiver in accordance with various aspects of the present disclosure;

FIG. 3 illustrates an example of a message format that supports the PHY layer for an ultra-low power wireless receiver in accordance with various aspects of the present disclosure;

FIG. 4 illustrates an example of a bit transformation that supports the PHY layer for an ultra-low power wireless receiver in accordance with various aspects of the present disclosure;

FIG. 5 illustrates an example of a process flow that supports the PHY layer for an ultra-low power wireless receiver in accordance with various aspects of the present disclosure;

FIG. 6-8 show block diagrams of a wireless device that supports the PHY layer for an ultra-low power wireless receiver in accordance with various aspects of the present disclosure;

FIG. 9 illustrates a block diagram of a system including a station (wireless device) that supports the PHY layer for an ultra-low power wireless receiver in accordance with various aspects of the present disclosure;

FIG. 10-12 show block diagrams of a wireless device that supports the PHY layer for an ultra-low power wireless receiver in accordance with various aspects of the present disclosure;

FIG. 13 illustrates a block diagram of a system including an access point (AP) that supports the PHY layer for an ultra-low power wireless receiver in accordance with various aspects of the present disclosure; and

FIGS. 14-17 illustrate methods for PHY layer for an ultra-low power wireless receiver in accordance with various aspects of the present disclosure.

### DETAILED DESCRIPTION

The following description of the figures illustrates various aspects of a physical (PHY) layer for an ultra-low power wireless receiver. Aspects of the disclosure are described in the context of a wireless local area network (WLAN), but the disclosed methods and apparatuses may also be used with other wireless technologies. According to the disclosure, an access point (AP) of a network (or another transmitting device) may identify a pending communication for a receiving wireless device and transmit a wakeup message comprising a device specific sequence to a companion radio of the receiving device. The receiving device may receive the wakeup message using the companion radio, decode the message to obtain a device specific sequence, and activate a primary radio. Aspects of a message format used with the PHY layer are also described. Specifically, the wakeup message may include a preamble, a signal field, and a data field. In some cases, the wireless device may demodulate the wakeup message using ON-OFF keying (OOK) modulation. Aspects of the disclosure are also described using a process flow diagram, block diagrams, and flowcharts.

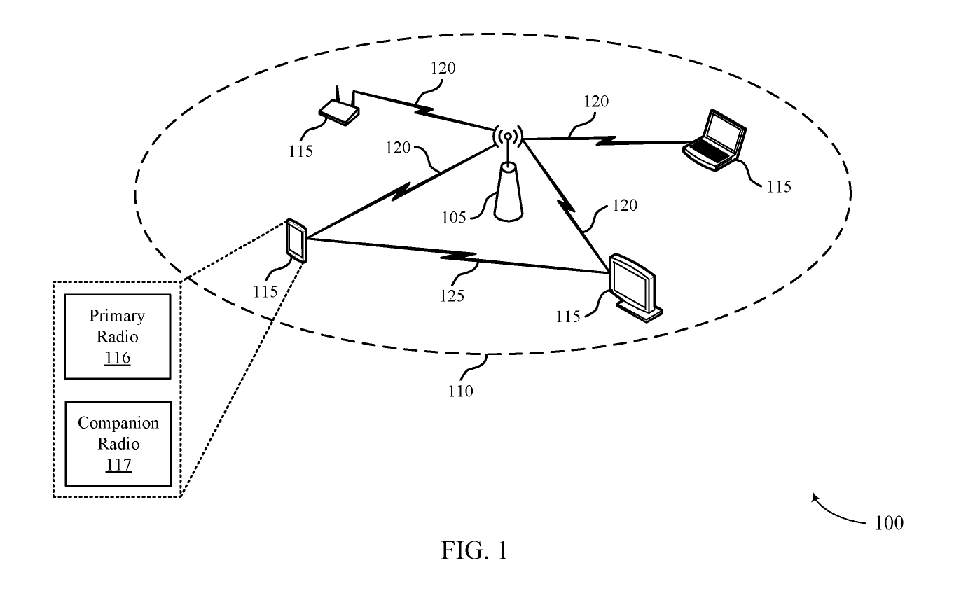

FIG. 1 illustrates a WLAN 100 (also known as a Wi-Fi network) configured in accordance with various aspects of the present disclosure. WLAN 100 is an example of a network for which the PHY layer for an ultra-low power wireless receiver may be used, but other networks may also utilize aspects of the disclosure. In one embodiment, an ultra-low power wireless receiver may be also referred to as a “wake-up receiver” (WuRX), where the ultra-low power wireless receiver consumes less power than a first (e.g., main) transceiver.

The PHY layer is the physical layer of the Open Systems Interconnection (OSI) model and may refer to the circuitry required to implement physical layer functions. In a Wi-Fi network, the PHY layer may consist of the radio frequency (RF), mixed-signal and analog portions (e.g., transceivers) and the digital baseband portion that uses digital signal processor (DSP) and communication algorithm processing, including channel codes. In some embodiments, the PHY layer may be integrated with the media access control (MAC) layer in System-on-a-chip (SOC) implementations.

WLAN 100 may include an AP 105 and multiple associated wireless devices 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of WLAN 100. An extended network station (not shown) associated with WLAN 100 may be connected to a wired or wireless distribution system (DS) that may allow multiple APs 105 to be connected in an ESS.

Although not shown in FIG. 1, a wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system (DS) (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 120 may include Wi-Fi Direct connections, Wi-Fi Tunneled Direct Link Setup (TDLS) links, and other group connections.

In some cases a wireless device 115 may enter a sleep mode to conserve power. The device may then wake periodically to receive a delivery traffic indication message (DTIM). The wireless device 115 may wake sufficiently early to activate the radio components used for DTIM reception. In some cases, the wireless device 115 may also wake early to account for possible timing asynchronization with the AP 105. If the DTIM is not received at the expected time, the wireless device 115 may wait for a beacon miss timer to expire. If a DTIM (or a standard traffic indication message (TIM)) is received, the wireless device 115 may then wait for the indicated transmission until a content after beacon (CAB) timer expires. If either timer expires, the wireless device 115 may re-enter sleep mode and wait for the next anticipated DTIM/beacon. In some cases, activating and deactivating a radio to receive DTIMs may still drain the battery of a power limited device (such as battery powered device that is part of an interne of things (JOT) network). Thus, a low power companion radio 117 may be used in addition to the primary radio 116 used for communication.

A low power radio may utilize a different modulation scheme than the primary radio 116. Modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a BPSK modulation scheme conveys information by alternating between waveforms that are transmitted with no phase offset or with a 180° offset (i.e., each symbol conveys a single bit of information). In a QAM scheme, two carrier signals (known as the in-phase component, I, and the quadrature component, Q) may be transmitted with a phase offset of 90°, and each signal may be transmitted with specific amplitude selected from a finite set. The number of amplitude bins determines the number of bits that are conveyed by each symbol. In some examples of the disclosure, a PHY layer for an ultra-low power wireless receiver may utilize ON-OFF keying (OOK) modulation and demodulation. OOK may be an example of amplitude modulation, in which information is conveyed by simply transmitting either at a given amplitude (for the ON part of the signal) or at a zero amplitude (for the OFF part of the signal).

According to the present disclosure, an AP 105 may identify a pending communication for a wireless device 115 and transmit a wakeup message comprising a device specific sequence to a companion radio 117 of the wireless device 115. The wireless device 115 may receive the wakeup message using the companion radio 117, decode the message to obtain a device specific sequence, and activate a primary radio 116. The wakeup message may include a preamble, a signal field, and a data field which may be based on OOK modulation. In some cases, the design of the PHY layer for the companion radio 117 may be based on operation in an unlicensed frequency spectrum. For example, it may be designed to achieve greater than a threshold bandwidth for a given power below peak of a power spectral density (PSD) representation.

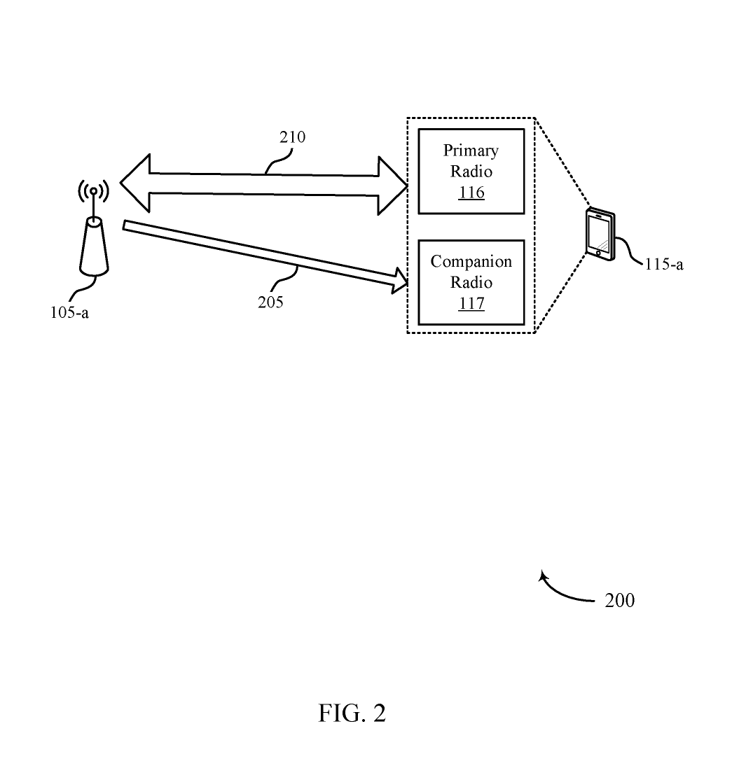

FIG. 2 illustrates an example of a wireless communications subsystem 200 for PHY layer for a companion radio 117 in accordance with various aspects of the present disclosure. Wireless communications subsystem 200 may include a wireless device 115-a and an AP 105-a, which may be an examples of a wireless device 115 and AP 105 described herein with reference to FIG. 1. AP 105-a may initiate communications with wireless device 115-a by transmitting a wakeup message comprising a device specific sequence using a first connection 205. Once wireless device 115-a has activated its primary radio 116, data may be exchanged over a second connection 210, which may be capable of a higher throughput than first connection 205. In one mode, the low power receiver may listen for a wake-up message and wake-up a primary radio, which can be placed into its lowest power. In another mode, the low power receiver may be used independently of a primary radio for low power communications (for example, the low power receiver may be used with a battery powered internet of things (IoT) device).

Wireless device 115-a may spend a portion of its time in a low power state to conserve power. Wireless device 115-a may also be equipped with both a primary radio 116 and a companion radio 117. The companion radio 117 may be a low power radio such as a super-regenerative receiver, so that wireless device 115-a may avoid activating the more power intensive primary radio 116 to receive periodic DTIM or paging messages. Instead, AP 105-a may transmit a wakeup message comprising a device specific sequence to the companion radio 117 of wireless device 115-a over a first connection 205. The PHY layer of the first connection 205 may be designed specifically for use with a low power radio. For example, it may have a reduced data rate and may be based on OOK modulation. If wireless device 115-a receives a wakeup message, it may activate a primary radio 116 (e.g., a WLAN radio based on an 802.11 standard) and communication with AP 105-a using the primary radio 116.

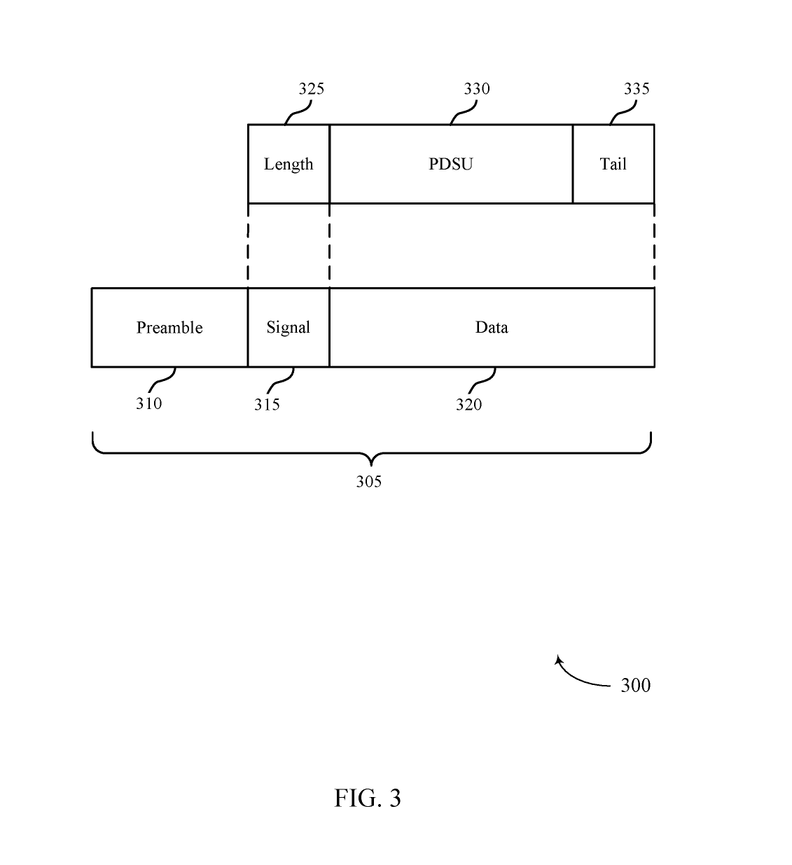

FIG. 3 illustrates an example of a message format 300 for PHY layer for an ultra-low power wireless receiver in accordance with various aspects of the present disclosure. Message format 300 may be designed for use by a low power receiver such as a super regenerative receiver (SRR) and may be used by a wireless device 115 or an AP 105 as described herein with reference to FIGS. 1-2. In one embodiment, the SRR may be a receiver enabled to use a lower-frequency oscillation within a same stage or in a second oscillation state to provide single-device circuit gains. The second oscillation stage may periodically interrupt a main radio frequency oscillation. After each interruption, the radio frequency oscillation may grow exponentially, wherein the amplitude reached at the end of the interrupt cycle may depend on the strength of the originally received signal.

Message format 300 may be used for a wakeup message 305, which may include a preamble 310, a signal field 315, and a data field 320. The preamble 310 may be used indicate that a transmission is a wakeup message 305 or to enable synchronization of the receiver. For example, the preamble 310 may include an automatic gain control (AGC) field, which may include 12 symbols. The preamble 310 may also include a pseudo-random noise (PN) sequence such as a length 511 maximal length sequence with an additional zero bit appended. Thus, in some examples, the preamble 310 may consist of 524 symbols (e.g., OOK symbols). However, this number is only an example, and other numbers or symbols may be used.

The signal field 315 may include a length indication 325 of the data field 320. In some cases, a parity bit is appended to the signal field. The parity bit may be used for detection of a bit error in decoding the signal field 315. In some cases, the parity bit may be generated using an exclusive of (XOR) function. In still further cases, the signal field may by encoded using a forward error correction (FEC) encoding such as a repetition-by-three code. Each code bit may also be mapped to a plurality of symbols using a spreading code. For example, each bit may be represented with 8 OOK symbols. However, this number is only an example, and other numbers or symbols may be used.

Data field 320 may include the message payload, including, for example, a device identifier for a receiving device, or an indication of data to be exchanged on a primary radio. In some cases, the payload is included in a physical layer service data unit (PSDU) 330. Data field 320 may also include a tail 335, which may include a number of zero bits appended to the end of PSDU 330. In some cases, decoding the signal field 315 with length indication 325 may enable decoding of the data field 320. In some cases, the bits of data field 320 may also be encoded using a spreading code such that each bit is represented using multiple symbols. In some cases the spreading code used for signal field 315 or data field 320 may incorporate a first set of OOK symbols for a “0” bit and a second set of symbols for a “1” bit. The sets of symbols for the different bits may be orthogonal, and may be transmitted such that a baseband representation of each set may have zero direct current (DC) value.

To achieve the zero DC value, or to achieve a desired pulse shape, ternary OOK modulation may be used at the transmitter. That is, half of the “one” OOK symbols are replaced by “negative one” symbols at baseband. Hence, when the baseband signal is modulated by an RF carrier, there may be little or no impulse in the frequency domain at the carrier frequency. This may be important in the unlicensed frequency band, since the signal bandwidth is measured at, e.g., 6-dB below the peak of the power spectral density (PSD), and in the case of a traditional OOK waveform it may result in a very low bandwidth. In some unlicensed frequency bands (e.g., 900 MHz and 2.4 GHz bands) in order to transmit above a very low power level the signal bandwidth may be greater directed to be greater than 500 kHz. Ternary OOK elimination of the frequency domain impulse at the carrier frequency may enable the signal bandwidth to be greater than a threshold (e.g., 500 kHz) and hence meet a regulatory requirement for a particular dB from peak bandwidth greater than the threshold.

The low power receiver may recover samples from the envelope of the received signal, and may only measure the magnitude of the signal, and cannot detect any phase information. Hence at the super regenerative receiver both “one” and “negative one” OOK symbols may be detected as “one” OOK symbols. As an example, the transmit sequence of ternary OOK symbols {0,1,1,0,0,−1,−1,0} may be received at the low power receiver as {0,1,1,0,0,1,1,0}. In one example, the PHY layer may utilize ternary OOK by converting a maximal length sequence into a sequence of ternary OOK symbol which may be received at the low power receiver as a binary maximal length sequence.

In some examples, spread spectrum spreading and forward error correction coding may be used to lower the data rate, and hence improve the receiver sensitivity, while maintaining a baud rate (e.g., of 500 kHz), in order to meet the regulatory requirement of greater than the threshold bandwidth. Spreading by, for example 8×, may provide not only improved sensitivity but also may provide sufficient symbol transitions at the receiver to dispense with bit scrambling at the transmitter. Thus, in some examples, the overall PHY packet structure may include an AGC field, a ternary maximal length sequence, a coded and spread signal field, and a coded and spread data field.

In some cases, data field 320 may be encoded using a convolutional code, for example, with a coding rate of 1/2. However, this number is only an example, and other coding rates may be used. In some cases, the transmitter may concatenate a LENGTH field from the with data and tail bits, and encode concatenated segment with the rate 1/2 convolutional code. In some cases, messages generated using message format 300 may also be processed by a pulse shaping filter prior to transmission, up-converted to radio frequency (RF), and transmitted based on a center frequency and clock frequency tolerance.

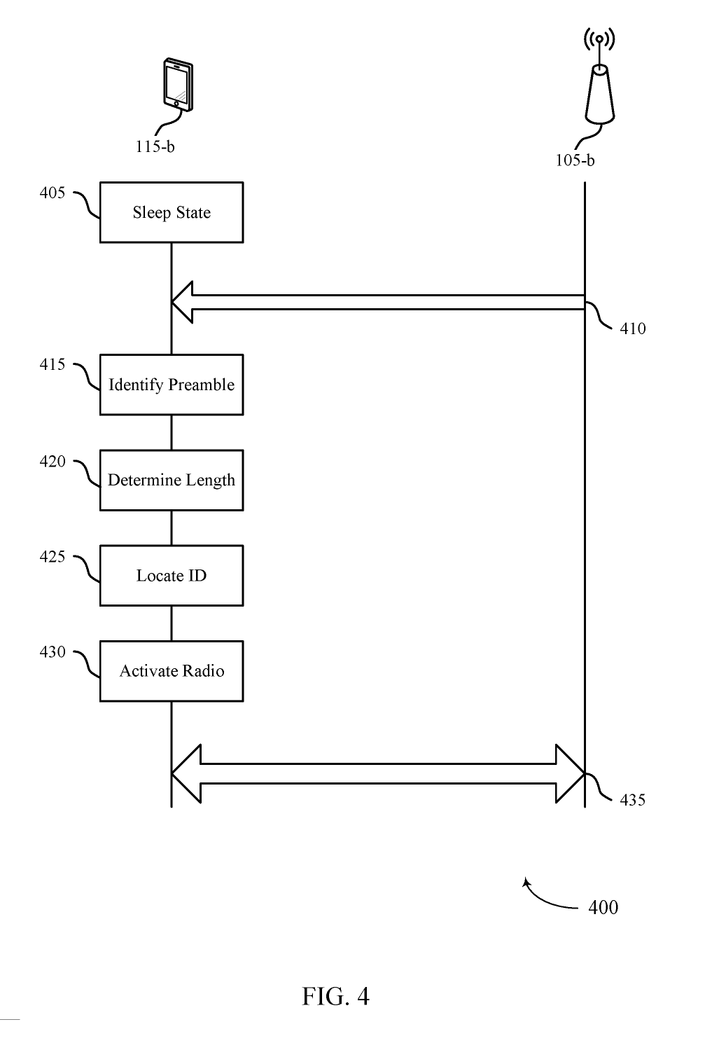

FIG. 4 illustrates an example of a process flow 400 for PHY layer for an ultra-low power wireless receiver in accordance with various aspects of the present disclosure. Process flow 400 may represent the operation of a wireless device 115-b and an AP 105-b, which may be examples of the devices described herein with reference to FIGS. 1-2. In some cases, the operations described as being performed by AP 105-b may be performed by another wireless device 115, such as a in peer mesh network or in device-to-device (D2D) communications.

At 405, wireless device 115-b may operate in a low power mode (e.g., in a sleep state). In the lower power mode, wireless device may operate a low power companion radio either continuously or periodically to receive paging messages or DTIMs and deactivate a second, primary radio. In some examples the first radio is a companion radio, which may include a super regenerative receiver (SRR). In some examples a second radio has a higher throughput capacity than the first radio. In some examples the second radio is a WLAN radio or a wireless wide area network (WWAN) radio.

At 410, AP 105-b may transmit, and wireless device 115 may receive, a wakeup message at a first radio (e.g., at a companion radio). In some examples, the wakeup message comprises a preamble, a signal field and a data field, wherein the device specific sequence is located within the data field. In some examples the preamble comprises an automatic gain control (AGC) field and a pseudo-random noise (PN) field. In some examples, the signal field indicates the length of the data field. In some examples, a DC value of a baseband representation of the preamble, the signal field, the data field, or any combination thereof is zero. In some examples, the data field comprises a physical layer service data unit (PSDU) and a tail of zero-valued bits. In some examples, the signal field, the data field, or any combination thereof is based at least in part on a spreading code.

In some cases, AP 105-b may identify a pending communication for wireless device 115-b prior to transmitting the wakeup message.

Wireless device 115-b may demodulate the wakeup message using ON-OFF keying (OOK) modulation, wherein decoding the wakeup message is based at least in part on the demodulation.

At 415, wireless device 115-b may identify a wakeup message preamble, which may enable it to determine that the transmission is the wakeup message.

At 420, wireless device 115-b may decode the signal field of the wakeup message to determine the length of the data field.

At 425, wireless device 115-b may decode the data field or another field of the wakeup message to obtain a device specific sequence.

At 430, wireless device 115-b may activate a second radio based at least in part on decoding the device specific sequence.

At 435, AP 105-b and wireless device 115-b may exchange data with a second radio of the wireless device 115-b based at least in part on the pending communication and the wakeup message.

FIG. 4 illustrates an example of a bit transformation 500 that supports the PHY layer for an ultra-low power wireless receiver in accordance with various aspects of the present disclosure. Bit transformation 500 may include binary OOK inputs 505-a and 505-b, transformations 510-a and 510-b, and ternary OOK outputs 515-a and 515-b.

In some regulatory domains there may be a minimum bandwidth constraint on the wireless transmission in some unlicensed bands. In some versions of OOK, which may be a digital modulation of the RF signal, in the frequency domain there may be a strong signal at the carrier frequency. This may lead to a narrowband signal when measured at a point where the signal may be 6 dB lower (i.e. 6 dB down) than at the peak value in the frequency domain. So the bandwidth of OOK signal may be narrowband and hence may not meet a minimum bandwidth standard. This may be true even when the modulation rate is increased, since the 6-db bandwidth may be controlled by the strong carrier signal in the frequency domain. Thus, some versions of OOK may not meet a minimum bandwidth standard as specified by the regulator. Or, in some cases, the allowed transmit power may be very low, leading to poor range for the wireless system.

However, in some cases a wireless communication device may utilize a characteristic of a low power receiver such as an SRR in which the receiver detects the envelope of the RF signal and does not distinguish between two different RF signals with a different phase. For example, a low power receiver may detect the same value for the following two signals:

s₁=sin(2πf₀t)

s₂=sin(2πf₀t+π)=−sin(2πf₀)

In OOK one may have two amplitudes of a signal: A and 0, where A may be based on the average transmit power. If one factors out the A which only depends on the average transmit power one can say that there are two amplitudes: 1 and 0.

Thus, transformation 510-a may map some of the “1” OOK symbols to “−1” symbols so that there may be a phase difference of π (i.e. 180°). One can think of this as having two logical values: 1 and 0, while having three actual amplitudes on the RF signal: −1, 0 and 1. At the transmitter half of the logical 1's may be mapped to actual amplitude of 1 and half of the logical 1's are mapped to actual amplitude of −1.

Thus, at baseband one may have the following mapping: with half the logical 1's mapped to amplitude 1 and half the logical 1's mapped to amplitude −1 the average power at the baseband signal may be zero. At RF there may be three RF symbols,

$$A sin ( 2 π {f}_{0} t )$$

$$A sin ( 2 π {f}_{0} t + π )$$

$$0$$

Since the low power receiver may not distinguish phase, it may detect just two amplitude levels: A and 0, which correspond to the original logical 1 and 0. Thus, the transmitter may transmit using ternary OOK, and the receiver may demodulate the message using binary OOK. As a result, in the frequency domain of the RF signal there may no longer be a strong narrowband signal at the carrier frequency. This may results in a wider band signal that can meet a regulatory minimum bandwidth standard. This may allow the transmitter to transmit at a higher power level and hence provide longer range.

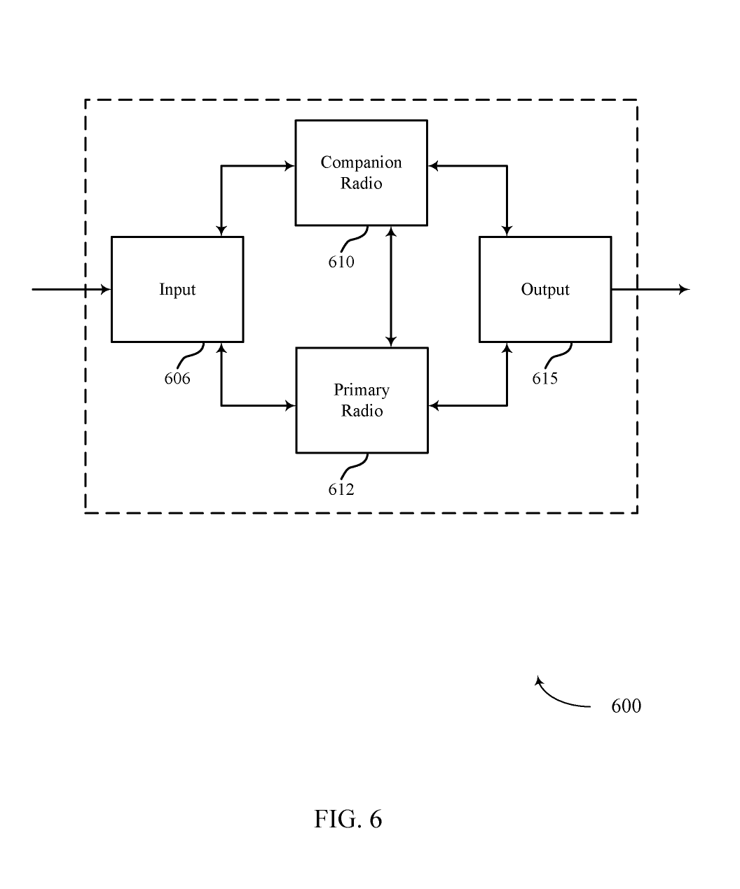

FIG. 6 shows a block diagram of a wireless device 600 configured for PHY layer for an ultra-low power wireless receiver in accordance with various aspects of the present disclosure. Wireless device 600 may be an example of aspects of a wireless device 115 described with reference to FIGS. 1-4. Wireless device 600 may include an input 605, a companion radio 610, a primary radio 612 or an output 615. Input 605 and output 615 may include one or more antenna arrays. Wireless device 600 may also include a processor. Each of these components may be in communication with each other.

The components of wireless device 600 may, individually or collectively, be implemented with at least one application specific integrated circuit (ASIC) adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The input 605 may receive information such as packets, user data, or control information associated with various information channels (e.g., control channels, data channels, and information related to PHY layer for an ultra-low power wireless receiver, etc.). Information may be passed on to the companion radio 610, primary radio 612, and to other components of wireless device 600.

The companion radio 610 may receive a wakeup message at a first radio, decode the wakeup message to obtain a device specific sequence, and activate a second radio based at least in part on decoding the device specific sequence.

The output 615 may transmit signals received from other components of wireless device 600. In some examples, the output 615 may be collocated with the input 605 in a transceiver. The output 615 may include a single antenna, or it may include a plurality of antennas.

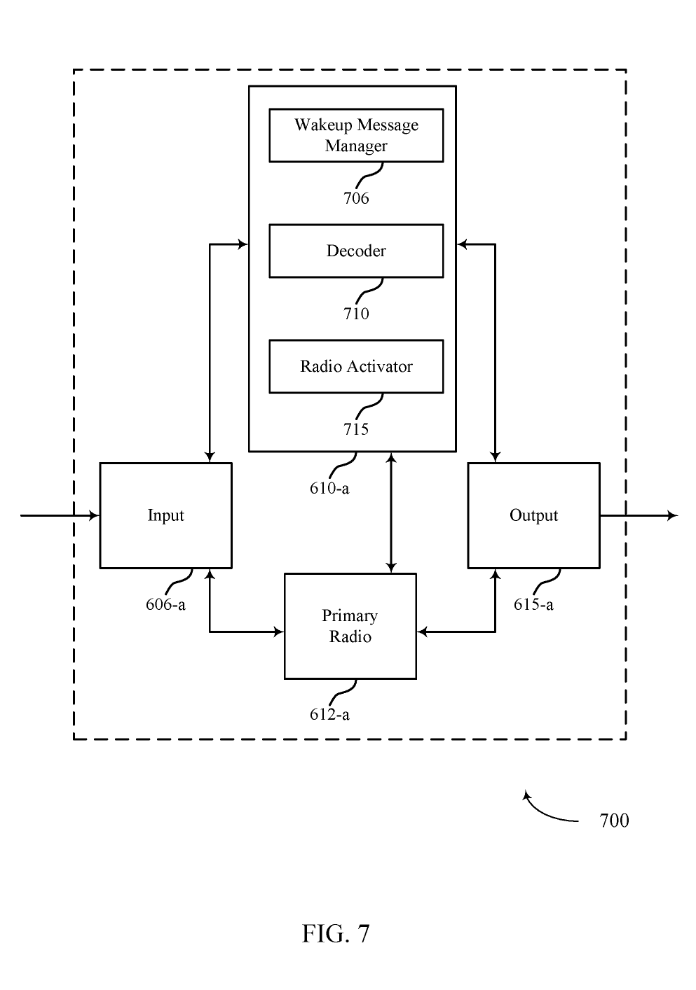

FIG. 7 shows a block diagram of a wireless device 700 for PHY layer for an ultra-low power wireless receiver in accordance with various aspects of the present disclosure. Wireless device 700 may be an example of aspects of a wireless device 600 or a wireless device 115 described with reference to FIGS. 1-6. Wireless device 700 may include a input 605-a, a companion radio 610-a, a primary radio 612-a, or an output 615-a. Wireless device 700 may also include a processor. Each of these components may be in communication with each other. The companion radio 610-a may also include a wakeup message manager 705, a decoder 710, and a radio activator 715.

The components of wireless device 700 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The input 605-a may receive information which may be passed on to companion radio 610-a, and to other components of wireless device 700. The companion radio 610-a may perform the operations described herein with reference to FIG. 6. The output 615-a may transmit signals received from other components of wireless device 700.

The wakeup message manager 705 may receive a wakeup message at a first radio as described herein with reference to FIGS. 2-4. In some examples, the wakeup message comprises a preamble, a signal field and a data field, wherein the device specific sequence may be located within the data field. In some examples, a DC value of a baseband representation of the preamble, the signal field, the data field, or any combination thereof may be zero. In some examples, the signal field, the data field, or any combination thereof may be based at least in part on a spreading code. In some examples, the first radio may be a low power receiver. In some examples, the first radio may be a super regenerative receiver (SRR). In some examples, the wakeup message comprises a preamble, a signal field and a data field, wherein the device specific sequence may be located within the data field. In some examples, a DC value of a baseband representation of the preamble, the signal field, the data field, or any combination thereof may be zero. In some examples, the signal field, the data field, or any combination thereof may be based at least in part on a spreading code. In some examples, the first radio may be a low power receiver. In some examples, the first radio may be a super regenerative receiver (SRR).

The decoder 710 may decode the wakeup message to obtain a device specific sequence as described herein with reference to FIGS. 2-4.

The radio activator 715 may activate a second radio (such as primary radio 612-a) based at least in part on decoding the device specific sequence as described herein with reference to FIGS. 2-4. In some examples, the second radio has a higher throughput capacity than the first radio. In some examples, the second radio may be a WLAN radio or a WWAN radio.

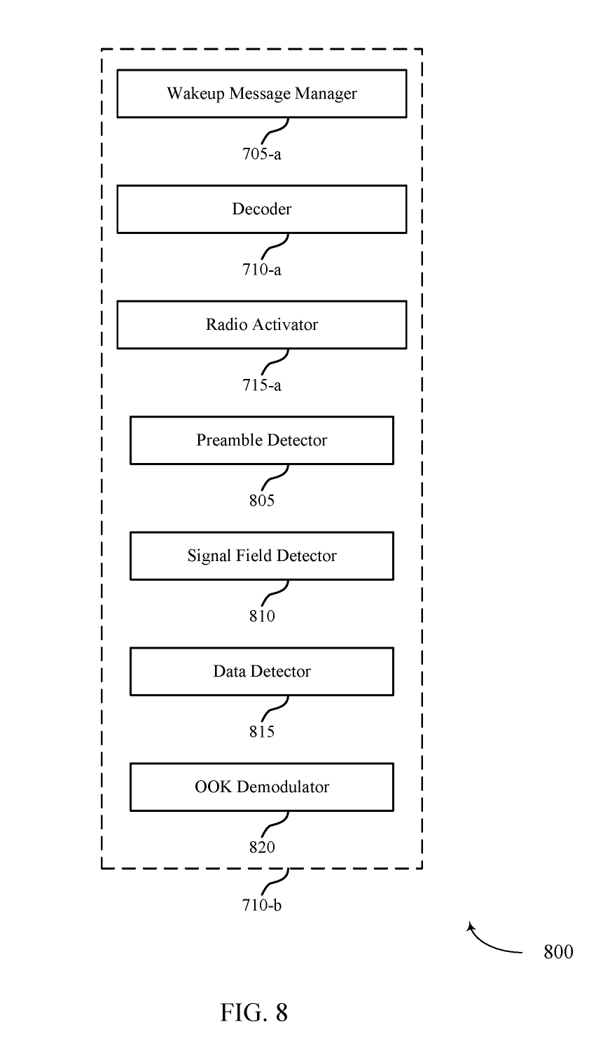

FIG. 8 shows a block diagram 800 of a companion radio 610-b which may be a component of a wireless device 600 or a wireless device 700 for PHY layer for an ultra-low power wireless receiver in accordance with various aspects of the present disclosure. The companion radio 610-b may be an example of aspects of a companion radio 610 described with reference to FIGS. 6-7. The companion radio 610-b may include a wakeup message manager 705-a, a decoder 710-a, and a radio activator 715-a. Each of these components may perform the functions described herein with reference to FIG. 7. The companion radio 610-b may also include a preamble detector 805, a signal field detector 810, a data detector 815, and an OOK demodulator 820.

The components of the companion radio 610-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The preamble detector 805 may be configured such that the preamble may include an AGC field and a PN field as described herein with reference to FIGS. 2-4.

The signal field detector 810 may be configured such that the signal field indicates the length of the data field as described herein with reference to FIGS. 2-4.

The data detector 815 may be configured such that the data field may include a physical layer service data unit (PSDU) and a tail of zero-valued bits as described herein with reference to FIGS. 2-4.

The OOK demodulator 820 may demodulate the wakeup message using OOK modulation, wherein decoding the wakeup message is based at least in part on the demodulation as described herein with reference to FIGS. 2-4.

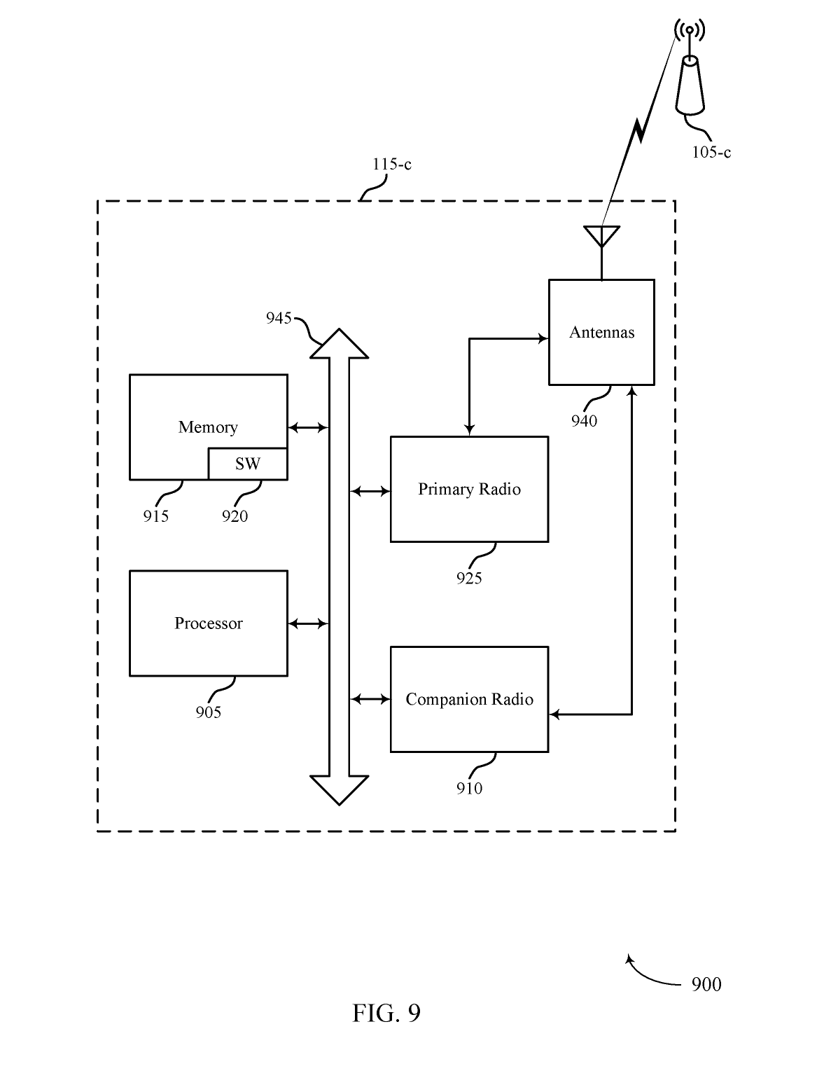

FIG. 9 shows a diagram of a system 900 including a wireless device 115 configured for PHY layer for an ultra-low power wireless receiver in accordance with various aspects of the present disclosure. System 900 may include wireless device 115-c, which may be an example of a wireless device 600, a wireless device 700, or a wireless device 115 described herein with reference to FIGS. 1, 2 and 6-8. Wireless device 115-c may include a companion radio 910 and a primary radio 925, which may be an example of a companion radio 610 and primary radio 612 described with reference to FIGS. 6-8. Wireless device 115-c may also include components for bi-directional voice and data communications including components for transmitting communications and components for receiving communications. For example, wireless device 115-c may communicate bi-directionally with AP 105-c

Wireless device 115-c may also include a processor 905, and memory 915 (including software (SW)) 920, each of which may communicate, directly or indirectly, with one another (e.g., via buses 945). Wireless device 115-c may also include one or more antenna(s) 940. Wireless device 115-c may communicate bi-directionally, via the antenna(s) 940 or wired or wireless links, with one or more networks, as described above. For example, the wireless device 115-c may communicate bi-directionally with an AP 105 or another wireless device 115. Wireless device 115-c may include a modem to modulate the packets and provide the modulated packets to the antenna(s) 940 for transmission, and to demodulate packets received from the antenna(s) 940. While wireless device 115-c may include a single antenna 940, wireless device 115-c may also have multiple antennas 940 capable of concurrently transmitting or receiving multiple wireless transmissions.

The memory 915 may include random access memory (RAM) and read only memory (ROM). The memory 915 may store computer-readable, computer-executable software/firmware code 920 including instructions that, when executed, cause the processor 905 to perform various functions described herein (e.g., PHY layer for an ultra-low power wireless receiver, etc.). Alternatively, the software/firmware code 920 may not be directly executable by the processor 905 but cause a computer (e.g., when compiled and executed) to perform functions described herein. The processor 905 may include an intelligent hardware device, (e.g., a central processing unit (CPU), a microcontroller, an ASIC, etc.)

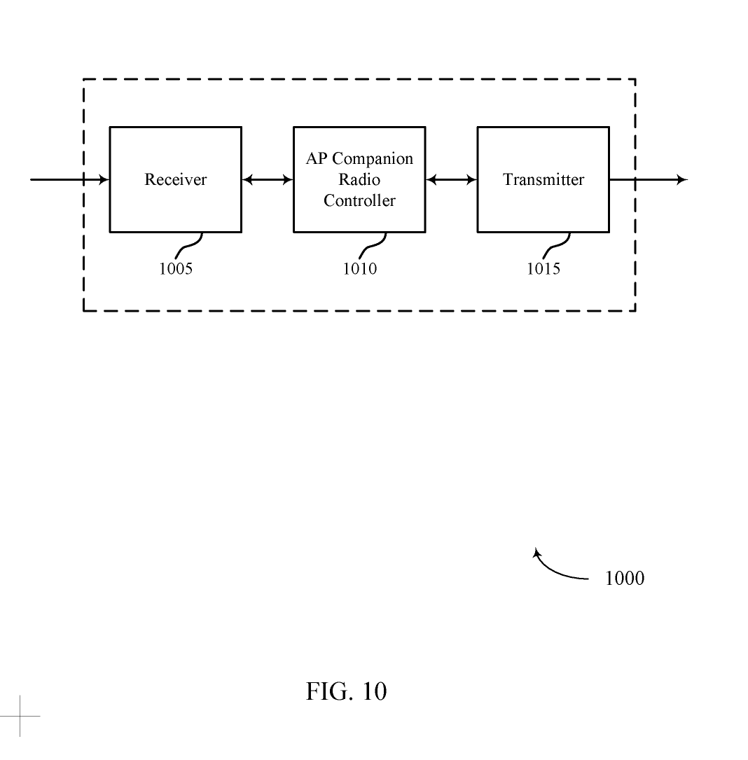

FIG. 10 shows a block diagram of a wireless device 1000 configured for PHY layer for an ultra-low power wireless receiver in accordance with various aspects of the present disclosure. Wireless device 1000 may be an example of aspects of an AP 105 described with reference to FIGS. 1-9. Wireless device 1000 may include a receiver 1005, an AP companion radio 1010, or a transmitter 1015. Wireless device 1000 may also include a processor. Each of these components may be in communication with each other.

The components of wireless device 1000 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1005 may receive information such as packets, user data, or control information associated with various information channels (e.g., control channels, data channels, and information related to PHY layer for an ultra-low power wireless receiver, etc.). Information may be passed on to the AP companion radio 1010, and to other components of wireless device 1000.

The AP companion radio 1010 may identify a pending communication for a wireless device, transmit a wakeup message comprising a device specific sequence to a first radio of the wireless device, and exchange data with a second radio of the wireless device based at least in part on the pending communication and the wakeup message.

The transmitter 1015 may transmit signals received from other components of wireless device 1000. In some examples, the transmitter 1015 may be collocated with the receiver 1005 in a transceiver. The transmitter 1015 may include a single antenna, or it may include a plurality of antennas.

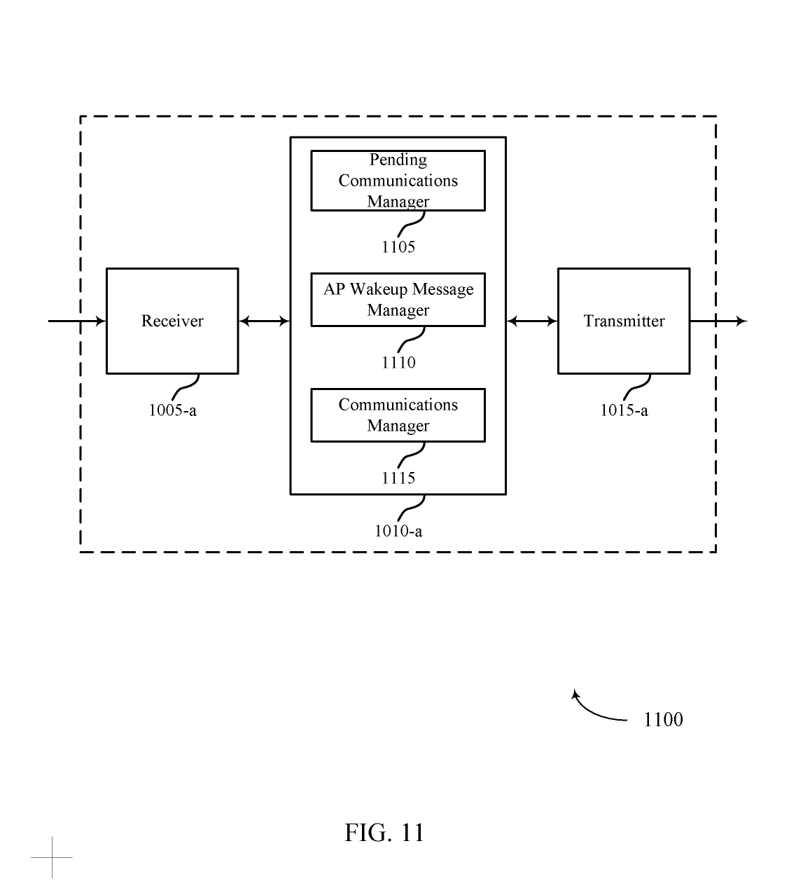

FIG. 11 shows a block diagram of a wireless device 1100 for PHY layer for an ultra-low power wireless receiver in accordance with various aspects of the present disclosure. Wireless device 1100 may be an example of aspects of a wireless device 1000 or an AP 105 described with reference to FIGS. 1-10. Wireless device 1100 may include a receiver 1005-a, an AP companion radio 1010-a, or a transmitter 1015-a. Wireless device 1100 may also include a processor. Each of these components may be in communication with each other. The AP companion radio 1010-a may also include a pending communications manager 1105, a AP wakeup message manager 1110, and a communications manager 1115.

The components of wireless device 1100 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1005-a may receive information which may be passed on to AP companion radio 1010-a, and to other components of wireless device 1100. The AP companion radio 1010-a may perform the operations described herein with reference to FIG. 10. The transmitter 1015-a may transmit signals received from other components of wireless device 1100.

The pending communications manager 1105 may identify a pending communication for a wireless device as described herein with reference to FIGS. 2-4.

The AP wakeup message manager 1110 may transmit a wakeup message comprising a device specific sequence to a first radio of the wireless device as described herein with reference to FIGS. 2-4.

The communications manager 1115 may exchange data with a second radio of the wireless device based at least in part on the pending communication and the wakeup message as described herein with reference to FIGS. 2-4. In some examples, the second radio has a higher throughput capacity than the first radio. In some examples, the second radio may be a WLAN radio or a WWAN radio.

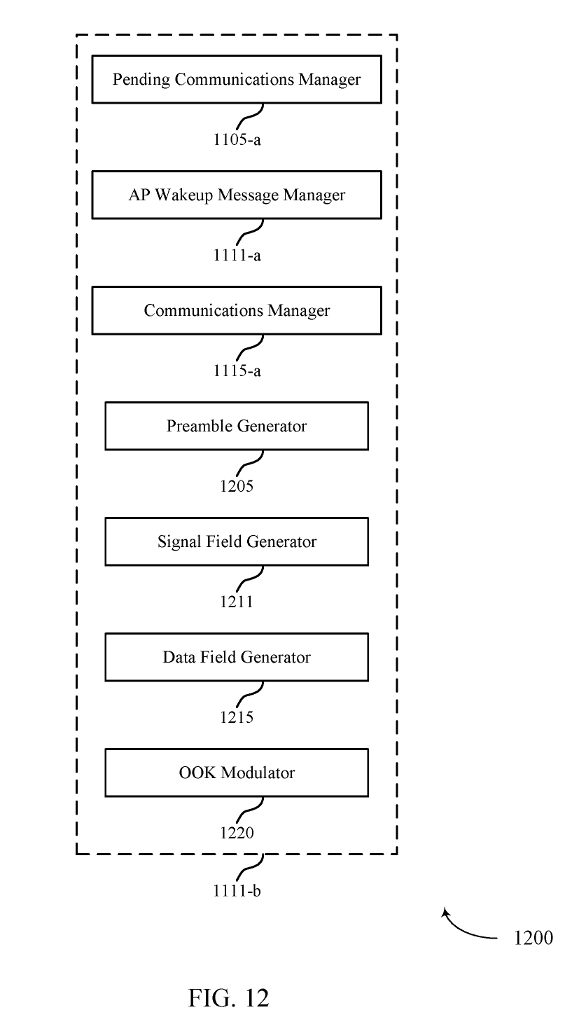

FIG. 12 shows a block diagram 1200 of an AP companion radio 1010-b which may be a component of a wireless device 1000 or a wireless device 1100 for PHY layer for an ultra-low power wireless receiver in accordance with various aspects of the present disclosure. The AP companion radio 1010-b may be an example of aspects of an AP companion radio 1010 described with reference to FIGS. 10-11. The AP companion radio 1010-b may include a pending communications manager 1105-a, a AP wakeup message manager 1110-a, and a communications manager 1115-a. Each of these components may perform the functions described herein with reference to FIG. 11. The AP companion radio 1010-b may also include a preamble generator 1205, a signal field generator 1210, a data field generator 1215, and an OOK modulator 1220.

The components of the AP companion radio 1010-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The preamble generator 1205 may be configured such that the preamble may include an AGC field and a PN field as described herein with reference to FIGS. 2-4.

The signal field generator 1210 may be configured such that the signal field indicates the length of the data field as described herein with reference to FIGS. 2-4.

The data field generator 1215 may be configured such that the data field may include a physical layer service data unit (PSDU) and a tail of zero-valued bits as described herein with reference to FIGS. 2-4.

The OOK modulator 1220 may modulate a wakeup message using OOK modulation, wherein transmitting the wakeup message is based at least in part on the modulation as described herein with reference to FIGS. 2-4.

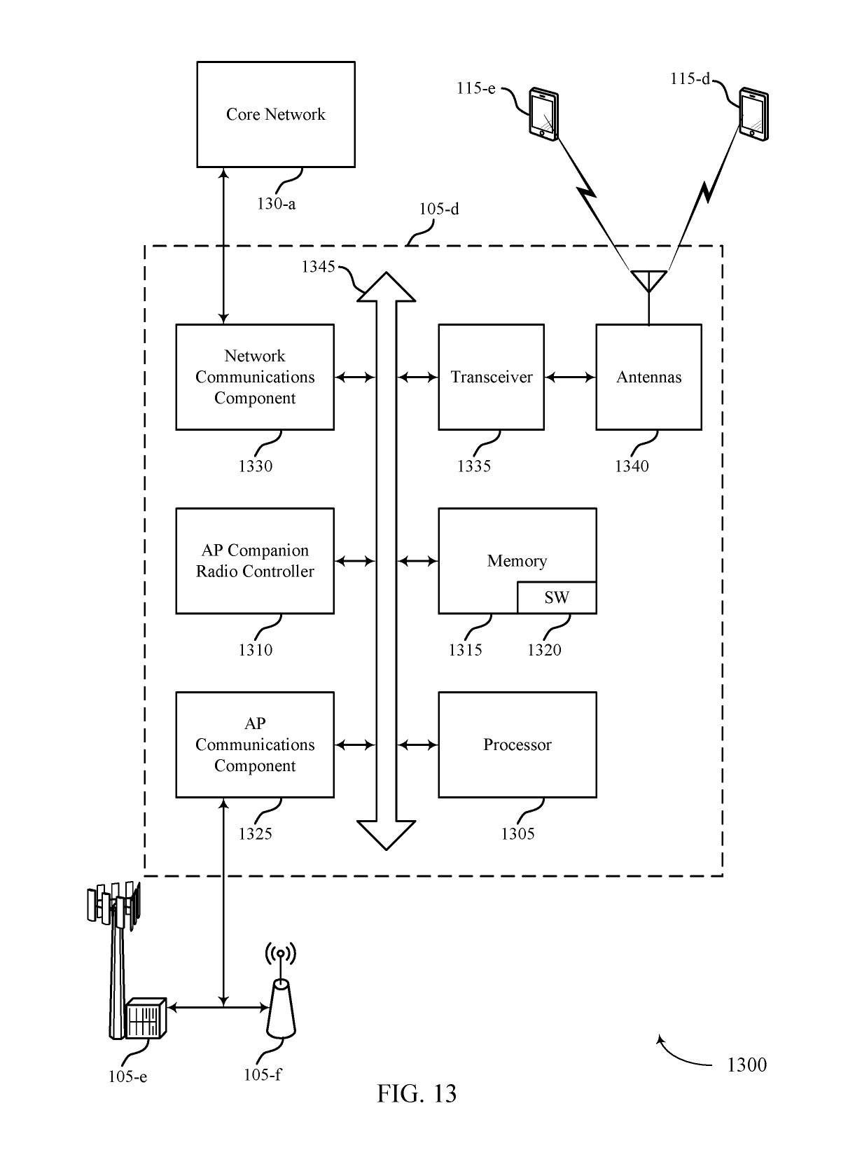

FIG. 13 shows a diagram of a system 1300 including an AP 105 configured for PHY layer for an ultra-low power wireless receiver in accordance with various aspects of the present disclosure. System 1300 may include AP 105-d, which may be an example of a wireless device 1000, a wireless device 1100, or an AP 105 described herein with reference to FIGS. 1, 2 and 10-12. AP 105-d may include an AP companion radio 1310, which may be an example of an AP companion radio 1010 described with reference to FIGS. 10-12. AP 105-d may also include components for bi-directional voice and data communications including components for transmitting communications and components for receiving communications. For example, AP 105-d may communicate bi-directionally with wireless device 115-d or wireless device 115-e.

In some cases, AP 105-d may have one or more wired backhaul links. AP 105-d may have a wired backhaul link (e.g., S1 interface, etc.) to the core network 130. AP 105-d may also communicate with other APs 105, such as AP 105-e and AP 105-f via inter-AP backhaul links. In some cases, AP 105-d may communicate with different APs 105 using different radio access technologies. For example, AP 105-e may be a WWAN AP 105 and AP 105-f may be a WLAN AP 105. Each of the APs 105 may communicate with wireless devices 115 using the same or different wireless communications technologies. In some cases, AP 105-d may communicate with other APs such as AP 105-e or 105-f utilizing AP communications component 1325. In some examples, AP communications component 1325 may provide an X2 interface within a Long Term Evolution (LTE)/LTE-A wireless communication network technology to provide communication between some of the APs 105. In some cases, AP 105-d may communicate with the core network 130 through network communications component 1330.

The AP 105-d may include a processor 1305, memory 1315 (including software (SW) 1320), transceiver 1335, and antenna(s) 1340, which each may be in communication, directly or indirectly, with one another (e.g., over bus system 1345). The transceiver 1335 may be configured to communicate bi-directionally, via the antenna(s) 1340, with the wireless devices 115, which may be multi-mode devices. The transceiver 1335 (or other components of the AP 105-d) may also be configured to communicate bi-directionally, via the antennas 1340, with one or more other APs (not shown). The transceiver 1335 may include a modem configured to modulate the packets and provide the modulated packets to the antennas 1340 for transmission, and to demodulate packets received from the antennas 1340. The AP 105-d may include multiple transceivers 1335, each with one or more associated antennas 1340. The transceiver may be an example of a combined receiver 1005 and transmitter 1015 of FIG. 10.

The memory 1315 may include RAM and ROM. The memory 1315 may also store computer-readable, computer-executable software code 1320 containing instructions that are configured to, when executed, cause the processor 1305 to perform various functions described herein (e.g., PHY layer for an ultra-low power wireless receiver, selecting coverage enhancement techniques, call processing, database management, message routing, etc.). Alternatively, the software 1320 may not be directly executable by the processor 1305 but be configured to cause the computer, e.g., when compiled and executed, to perform functions described herein. The processor 1305 may include an intelligent hardware device, e.g., a CPU, a microcontroller, an ASIC, etc. The processor 1305 may include various special purpose processors such as encoders, queue processing components, base band processors, radio head controllers, digital signal processor (DSPs), and the like.

The AP communications component 1325 may manage communications with other APs 105. The AP communications component 1325 may include a controller or scheduler for controlling communications with wireless devices 115 in cooperation with other APs 105. For example, the AP communications component 1325 may coordinate scheduling for transmissions to wireless devices 115 for various interference mitigation techniques such as beamforming or joint transmission.

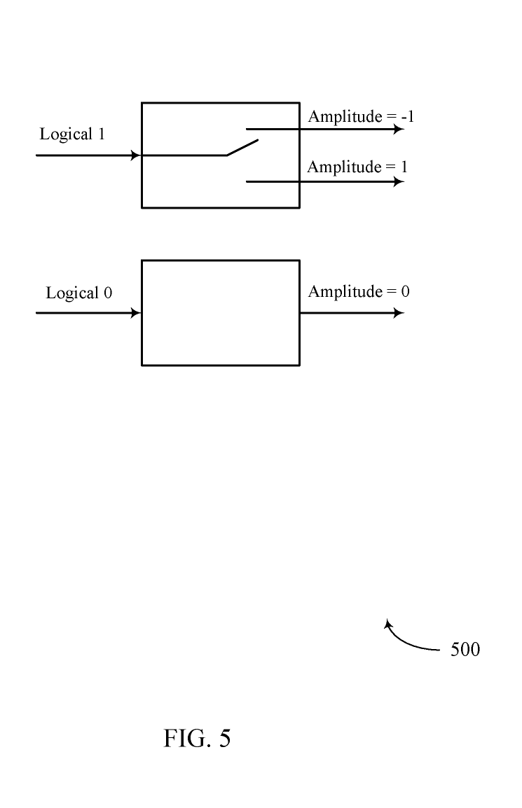

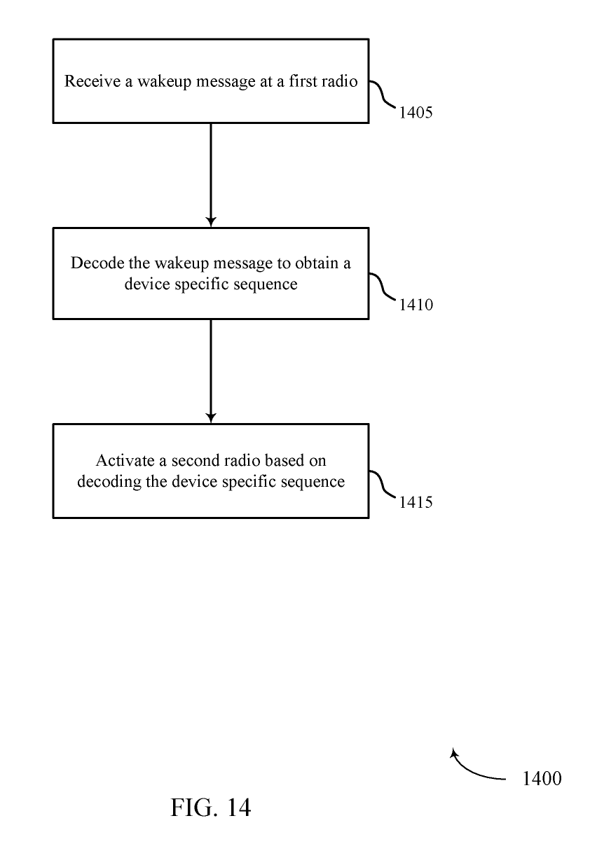

FIG. 14 shows a flowchart illustrating a method 1400 for PHY layer for an ultra-low power wireless receiver in accordance with various aspects of the present disclosure. The operations of method 1400 may be implemented by a wireless device 115 or its components as described with reference to FIGS. 1-13. For example, the operations of method 1400 may be performed by the companion radio 610 as described with reference to FIGS. 5-9. In some examples, a wireless device 115 may execute a set of codes to control the functional elements of the wireless device 115 to perform the functions described below. Additionally or alternatively, the wireless device 115 may perform aspects the functions described below using special-purpose hardware.

At block 1405, the wireless device 115 may receive a wakeup message at a first radio as described herein with reference to FIGS. 2-4. In certain examples, the operations of block 1405 may be performed by the wakeup message manager 705 as described herein with reference to FIG. 7.

At block 1410, the wireless device 115 may decode the wakeup message to obtain a device specific sequence as described herein with reference to FIGS. 2-4. In certain examples, the operations of block 1410 may be performed by the decoder 710 as described herein with reference to FIG. 7.

At block 1415, the wireless device 115 may activate a second radio based at least in part on decoding the device specific sequence as described herein with reference to FIGS. 2-4. In certain examples, the operations of block 1415 may be performed by the radio activator 715 as described herein with reference to FIG. 7.

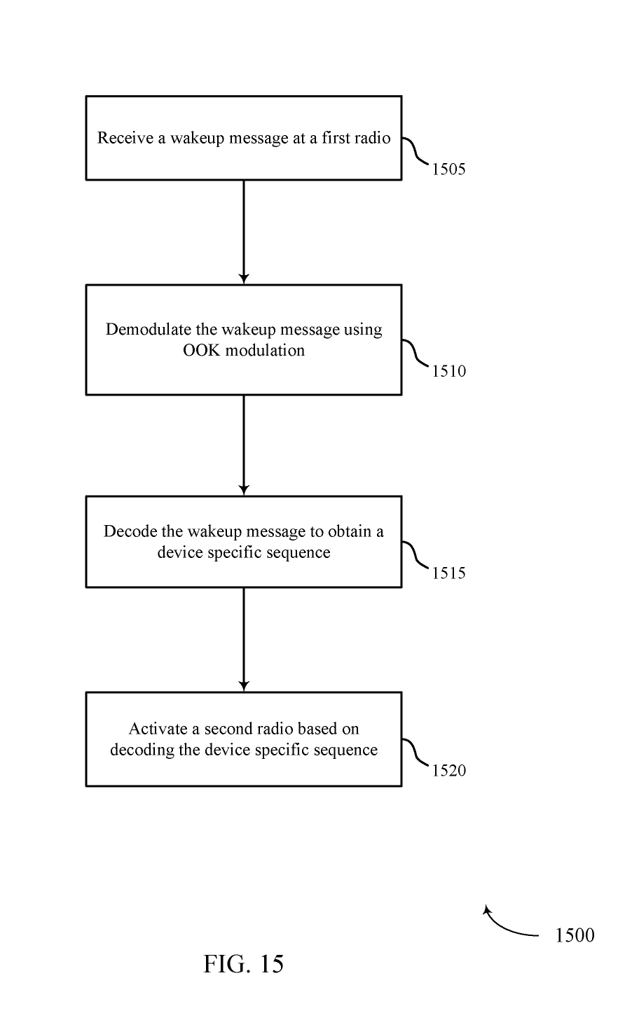

FIG. 15 shows a flowchart illustrating a method 1500 for PHY layer for an ultra-low power wireless receiver in accordance with various aspects of the present disclosure. The operations of method 1500 may be implemented by a wireless device 115 or its components as described with reference to FIGS. 1-13. For example, the operations of method 1500 may be performed by the companion radio 610 as described with reference to FIGS. 5-9. In some examples, a wireless device 115 may execute a set of codes to control the functional elements of the wireless device 115 to perform the functions described below. Additionally or alternatively, the wireless device 115 may perform aspects the functions described below using special-purpose hardware. The method 1500 may also incorporate aspects of method 1400 of FIG. 14.

At block 1505, the wireless device 115 may receive a wakeup message at a first radio as described herein with reference to FIGS. 2-4. In certain examples, the operations of block 1505 may be performed by the wakeup message manager 705 as described herein with reference to FIG. 7.

At block 1510, the wireless device 115 may demodulate the wakeup message using OOK modulation, wherein decoding the wakeup message is based at least in part on the demodulation as described herein with reference to FIGS. 2-4. In certain examples, the operations of block 1510 may be performed by the OOK demodulator 820 as described herein with reference to FIG. 8.

At block 1515, the wireless device 115 may decode the wakeup message to obtain a device specific sequence as described herein with reference to FIGS. 2-4. In certain examples, the operations of block 1515 may be performed by the decoder 710 as described herein with reference to FIG. 7.

At block 1520, the wireless device 115 may activate a second radio based at least in part on decoding the device specific sequence as described herein with reference to FIGS. 2-4. In certain examples, the operations of block 1520 may be performed by the radio activator 715 as described herein with reference to FIG. 7.

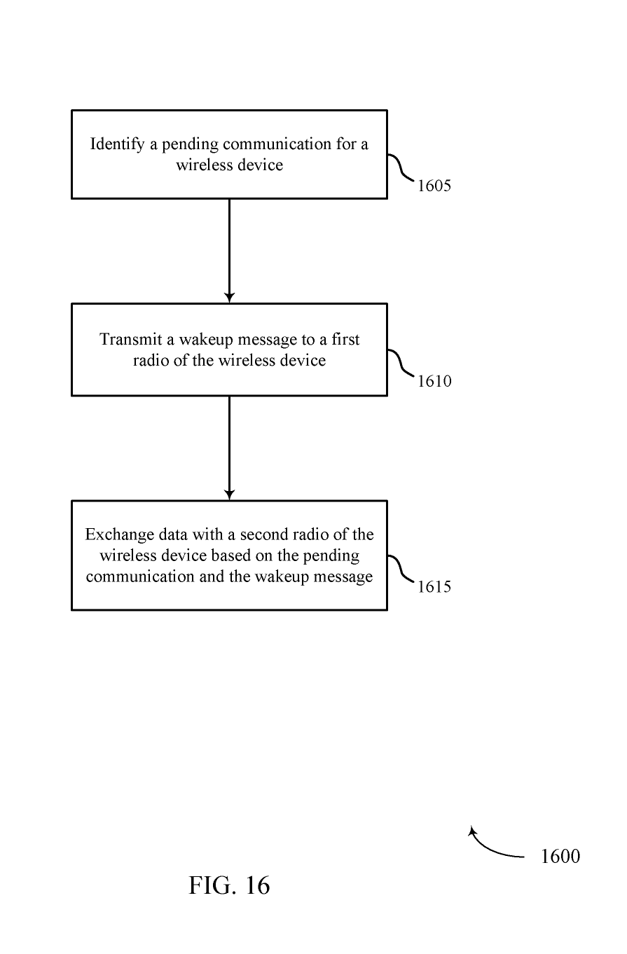

FIG. 16 shows a flowchart illustrating a method 1600 for PHY layer for an ultra-low power wireless receiver in accordance with various aspects of the present disclosure. The operations of method 1600 may be implemented by an AP 105 or its components as described with reference to FIGS. 1-13. For example, the operations of method 1600 may be performed by the AP companion radio 1010 as described with reference to FIGS. 10-13. In some examples, an AP 105 may execute a set of codes to control the functional elements of the AP 105 to perform the functions described below. Additionally or alternatively, the AP 105 may perform aspects the functions described below using special-purpose hardware. The method 1600 may also incorporate aspects of methods 1400, and 1500 of FIGS. 14-15.

At block 1605, the AP 105 may identify a pending communication for a wireless device as described herein with reference to FIGS. 2-4. In certain examples, the operations of block 1605 may be performed by the pending communications manager 1115 as described herein with reference to FIG. 11.

At block 1610, the AP 105 may transmit a wakeup message comprising a device specific sequence to a first radio of the wireless device as described herein with reference to FIGS. 2-4. In certain examples, the operations of block 1610 may be performed by the AP wakeup message manager 1110 as described herein with reference to FIG. 11.

At block 1615, the AP 105 may exchange data with a second radio of the wireless device based at least in part on the pending communication and the wakeup message as described herein with reference to FIGS. 2-4. In certain examples, the operations of block 1615 may be performed by the communications manager 1115 as described herein with reference to FIG. 11.

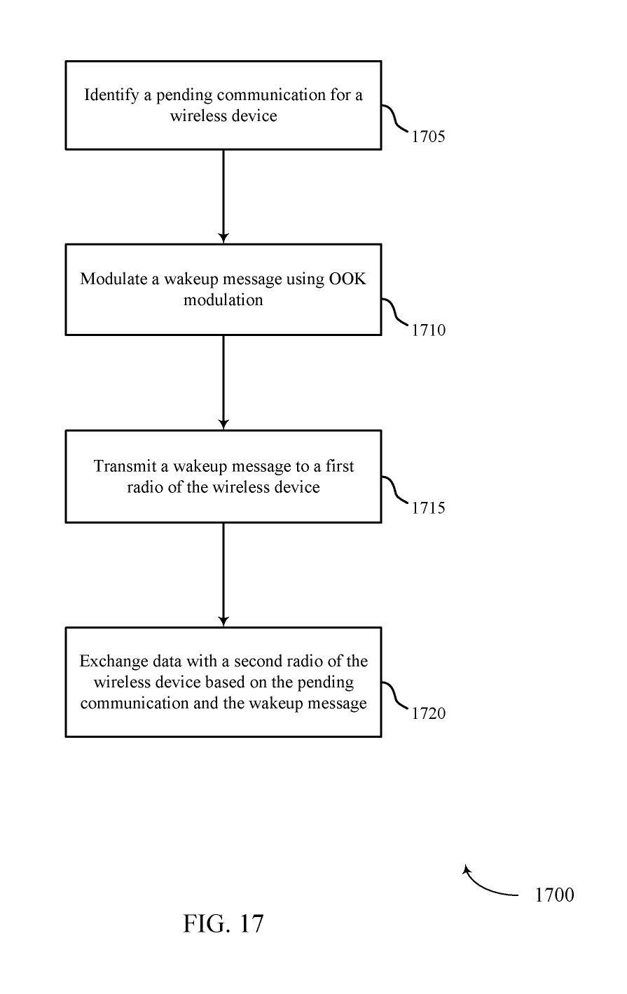

FIG. 17 shows a flowchart illustrating a method 1700 for PHY layer for an ultra-low power wireless receiver in accordance with various aspects of the present disclosure. The operations of method 1700 may be implemented by an AP 105 or its components as described with reference to FIGS. 1-13. For example, the operations of method 1700 may be performed by the AP companion radio 1010 as described with reference to FIGS. 10-13. In some examples, an AP 105 may execute a set of codes to control the functional elements of the AP 105 to perform the functions described below. Additionally or alternatively, the AP 105 may perform aspects the functions described below using special-purpose hardware. The method 1700 may also incorporate aspects of methods 1400, 1500, and 1600 of FIGS. 14-16.

At block 1705, the AP 105 may identify a pending communication for a wireless device as described herein with reference to FIGS. 2-4. In certain examples, the operations of block 1705 may be performed by the pending communications manager 1115 as described herein with reference to FIG. 11.

At block 1710, the AP 105 may modulate a wakeup message using OOK modulation, wherein transmitting the wakeup message is based at least in part on the modulation as described herein with reference to FIGS. 2-4. In certain examples, the operations of block 1710 may be performed by the OOK modulator 1220 as described herein with reference to FIG. 12.

At block 1715, the AP 105 may transmit a wakeup message comprising a device specific sequence to a first radio of the wireless device as described herein with reference to FIGS. 2-4. In certain examples, the operations of block 1715 may be performed by the AP wakeup message manager 1110 as described herein with reference to FIG. 11.

At block 1720, the AP 105 may exchange data with a second radio of the wireless device based at least in part on the pending communication and the wakeup message as described herein with reference to FIGS. 2-4. In certain examples, the operations of block 1720 may be performed by the communications manager 1115 as described herein with reference to FIG. 11.

Thus, methods 1400, 1500, 1600, and 1700 may provide for PHY layer for an ultra-low power wireless receiver. It should be noted that methods 1400, 1500, 1600, and 1700 describe possible implementation, and that the operations and the steps may be rearranged or otherwise modified such that other implementations are possible. In some examples, aspects from two or more of the methods 1400, 1500, 1600, and 1700 may be combined.

The detailed description set forth above in connection with the appended drawings describes exemplary configurations and does not represent all the examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
receiving a wakeup message at a first radio, wherein the wakeup message is modulated using a ternary ON-OFF keying (OOK) modulation comprising bits represented with positive and negative amplitude signals;
decoding the wakeup message to obtain a device specific sequence; and
activating a second radio based at least in part on decoding the device specific sequence.

2. The method of claim 1, wherein the wakeup message comprises a preamble, a signal field and a data field, wherein the device specific sequence is located within the data field.

3. The method of claim 2, wherein the preamble comprises an automatic gain control (AGC) field and a pseudo-random noise (PN) field.

4. The method of claim 2, wherein the signal field indicates a length of the data field.

5. The method of claim 2, wherein the data field comprises a physical layer service data unit (PSDU) and a tail of zero-valued bits.

6. A method of wireless communication, comprising:
identifying a pending communication for a wireless device;
transmitting a wakeup message comprising a device specific sequence to a first radio of the wireless device, wherein the wakeup message is modulated using a ternary ON-OFF keying (OOK) modulation comprising bits represented with positive and negative amplitude; and
exchanging data with a second radio of the wireless device based at least in part on the pending communication and the wakeup message.

7. The method of claim 6, wherein the wakeup message comprises a preamble, a signal field and a data field, wherein the device specific sequence is located within the data field.

8. The method of claim 7, wherein the preamble comprises an AGC field and a PN field.

9. The method of claim 7, wherein the signal field indicates a length of the data field.

10. The method of claim 7, wherein a DC value of a baseband representation of the preamble, the signal field, the data field, or any combination thereof is zero.

11. An apparatus for wireless communication, comprising:
a processor;
memory in electronic communication with the processor; and
instructions stored in the memory and operable, when executed by the processor, to cause the apparatus to:
receive a wakeup message at a first radio, wherein the wakeup message is modulated using a ternary ON-OFF keying (OOK) modulation comprising bits represented with positive and negative amplitude;
decode the wakeup message to obtain a device specific sequence; and
activate a second radio based at least in part on decoding the device specific sequence.

12. The apparatus of claim 12, wherein the second radio consumes less power than the first radio.

13. The apparatus of claim 11, wherein the wakeup message comprises a preamble, a signal field, and a data field, wherein the device specific sequence is located within the data field.

14. The apparatus of claim 13, wherein the preamble comprises an automatic gain control (AGC) field and a pseudo-random noise (PN) field.

15. The apparatus of claim 13, wherein the signal field indicates a length of the data field.

16. The apparatus of claim 13, wherein a parity bit is appended to the signal field.

17. The apparatus of claim 13, wherein a DC value of a baseband representation of the preamble, the signal field, the data field, or any combination thereof is zero.

18. The apparatus of claim 13, wherein the data field comprises a physical layer service data unit (PSDU) and a tail of zero-valued bits.

19. The apparatus of claim 13, wherein the signal field, the data field, or any combination thereof is based at least in part on a spreading code.

20. The apparatus of claim 11, wherein the instructions, when executed by the processor, further cause the apparatus to:
demodulate the wakeup message using OOK modulation, wherein decoding the wakeup message is based at least in part on the demodulation.

21. The apparatus of claim 11, wherein the first radio is a low power receiver.

22. The apparatus of claim 21, wherein the first radio is a super regenerative receiver (SRR).

23. The apparatus of claim 11, wherein the second radio has a higher throughput capacity than the first radio.

24. An apparatus for wireless communication, comprising:
a processor;
memory in electronic communication with the processor; and
instructions stored in the memory and operable, when executed by the processor, to cause the apparatus to:
identify a pending communication for a wireless device;
transmit a wakeup message comprising a device specific sequence to a first radio of the wireless device, wherein the wake up message is modulated using a ternary ON-OFF keying (OOK) modulation comprising bits represented with positive and negative amplitude signals; and
exchange data with a second radio of the wireless device based at least in part on the pending communication and the wakeup message.

25. The apparatus of claim 24, wherein the wakeup message comprises a preamble, a signal field and a data field, wherein the device specific sequence is located within the data field.

26. The apparatus of claim 25, wherein the preamble comprises an AGC field and a PN field.

27. The apparatus of claim 25, wherein the signal field indicates a length of the data field.

28. The apparatus of claim 25, wherein a DC value of a baseband representation of the preamble, the signal field, the data field, or any combination thereof is zero.

29. The apparatus of claim 25, wherein the data field comprises a physical layer service data unit (PSDU) and a tail of zero-valued bits.

30. The apparatus of claim 25, wherein the signal field, the data field, or any combination thereof is based at least in part on a spreading code.
